(19) United States
(12) Patent Application Publication
(10) Pub. No.: US 2024/0014887 A1
(43) Pub. Date: Jan. 11, 2024

(54) NON-REDUNDANT PASSIVE MULTIBEAM SATELLITE RADIO-COMMUNICATIONS SYSTEM

(71) Applicant: THALES, Courbevoie (FR)

(72) Inventors: Didier LE BOULCH, TOULOUSE (FR); Pierre BOSSHARD, TOULOUSE (FR); Philippe VOISIN, TOULOUSE (FR)

(21) Appl. No.: 18/217,280

(22) Filed: Jun. 30, 2023

(30) Foreign Application Priority Data
Jul. 7, 2022 (FR) 2206930

(51) Int. Cl. H04B 7/185

(52) U.S. Cl. CPC H04B 7/18513

(57) ABSTRACT

A multibeam satellite radiocommunications system includes at least one satellite having at least one passive multibeam antenna system, at least one satellite terminal, a resource allocator configured to form a regular network of satellite spots arranged according to a mesh in quadrilateral form over a given geographic zone, to associate spectral resources with the satellite spots, then to allocate spectral resources to the satellite terminals as a function of their position, wherein the resource allocator is configured to, in the event of failure of a satellite spot, extend the zone of coverage of the satellite spots adjacent to the failing satellite spot so as to cover the surface that it occupies, and allocate new spectral resources to the satellite terminals of the failing satellite spot as a function of their position. A resource allocator and the corresponding method are also provided.

### CROSS-REFERENCE TO RELATED APPLICATION

This application claims priority to foreign French patent application No. FR 2206930, filed on Jul. 7, 2022, the disclosure of which is incorporated by reference in its entirety.

### FIELD OF THE INVENTION

The invention falls within the field of satellite communications, and relates more particularly to a passive wideband multibeam satellite radiocommunications system, that is to say without redundancy of the amplification circuits, in which the robustness to failings is supported by the focal networks of the antennas, to a resource allocator for a satellite network and to the associated method for allocating satellite resources.

### BACKGROUND

The HTS (High Throughput System) or V-HTS (Very High Throughput System) payload solutions can be implemented using active or passive antennas.

Some of these solutions are based on the use of active antennas, in which the formation of the beams is performed by using all or part of the radiating feeds of the antenna. They offer performance levels that fall short with respect to the solutions based on the use of passive antennas, for which the formation of each beam is performed by a single radiating feed, in terms of directivity and of resource re-use capability. This decrease is intrinsic to the performance levels that can be achieved with the different antenna optics (active antenna with reflector or direct radiation array antenna).

In the solutions involving active antennas, the amplification is distributed, that is to say that each radiating element is associated with a transmission or reception amplifier and contributes to the formation of all of the beams produced by the antenna, and does so with or without reflective optic. For the systems with reflector optic, this is:
either conformed such that the energy associated with the diffraction spot of a radiating element is spread over all of the zone covered by the antenna. The term AFSR (acronym for Array-Fed-Shaped-Reflector) then applies, and the network of feeds is placed at the focal point of the antenna,
or the diffraction spot is spread over all of the radiating elements by the action of a displacement of the reflector, such that the feed network is no longer situated in the focal plane of the reflector. The term DAFR (for Defocused Array Fed Reflector) then applies.

The spreading of the energy causes the performance levels to fall short with respect to the passive focusing systems, associating a feed with a redundant antenna, for example of FAFR (acronym for Focal Array Fed Reflector) type.

However, one of the advantages of the solutions based on the use of active antennas lies in that they do not require the implementation of redundancy circuits, since the failure of a radiofrequency (RF) chain is reflected only by a low local reduction of the performance levels of the antenna, which can be limited to a perfectly acceptable threshold. This failure does not lead to “holes” in the coverage applied by the satellite. Thus, there is no need to make the RF chains (or RF front-ends) redundant, which makes it possible to locate them as close as possible to the radiating apertures, and therefore to considerably minimize the RF losses linked to the provision of redundancy loops. The performance gain is of the order of 2 dB to 2.5 dB in the Ka band, with respect to the passive solutions.

The HTS and V-HTS payload solutions based on the use of passive antennas of FAFR type, for which each satellite spot is associated with a distinct radiating feed, present other advantages and drawbacks. FIG. 1 schematically represents the different elements of such a solution, in the case of a satellite for which the payload is composed of a transmission antenna system and a reception antenna system that are distinct. The payload conventionally comprises a digital assembly 101 performing the routing of the frequency channels and the processing of the signals. It is linked on the one hand to a transmission part through amplification RF chains 111 for the signals to be transmitted (also called feeds) and radiating elements (or horns) 112, the radiating elements illuminating a parabolic reflector 113. The amplification RF chains 111 generally comprise power amplifiers (or High Power Amplifiers, HPA) in the form of travelling wave power tubes (or Travelling Wave Tube Amplifiers, TWTA) or solid state power amplifiers (SSPA) associated or not with frequency converters. So as to overcome any failures of the RF chains 111, the latter are made redundant. Their number is therefore greater than the number of beams formed. They are associated with redundancy circuits 114 and 115, so as to be able to mitigate any failures. Thus, the failure of an RF chain does not lead to the formation of a “hole” in the zone of coverage of the satellite (loss of the beam fed by the transmission and/or reception functions). The principle is the same in reception, where the signals reflected by a reflector 123 are acquired by radiating elements 122, and then processed by radio chains 121 comprising low-noise amplifiers (LNA). Redundancy circuits 124 and 125, comprising electromechanical or ferrite switches, make it possible to associate the different radio chains and feeds.

Such solutions present the advantage of offering very high performance levels in terms of antenna directivity and frequency re-use capability, but the placement of the redundance circuits leads to an overdimensioning of the payload and an increased complexity of the supply waveguides (use of redundancy rings), with impacts on the RF losses. The introduction of redundancy circuits generates significant cable loom lengths, which, with the increase of the number of RF chains and the introduction of switches, leads to a massive increase in the weight and the bulk of the payload, as well as increased integration and verification times needed to validate all the data paths.

In summary, the payload solutions based on passive antennas offer high performance levels but are associated with RF chains that are penalized in terms of performance because of the introduction of redundancy circuits. Conversely, the payload solution based on active antennas allow optimal use of the RF chains but present performance levels that fall short.

There is therefore a need for an architecture that brings together the best of the two solutions, namely a solution based on passive antennas having characteristics such that there is no need to make the RF chains of the repeater input and output sections redundant.

### SUMMARY OF THE INVENTION

To this end, the present invention describes a multibeam satellite radiocommunications system comprising:
at least one satellite having at least one passive multibeam antenna system,
at least one satellite terminal,
a resource allocator configured to:
   form a regular network of satellite spots over a given geographic zone, said satellite spot network being arranged according to a regular mesh in quadrilateral form, and
   associate spectral resources with the satellite spots such that, for each satellite spot, the spectral resources which are assigned to it differ from those assigned to the adjacent satellite spots, then
   allocate spectral resources to said at least one satellite terminal as a function of its position in said satellite spot network.

In the satellite radiocommunications system according to the invention, the resource allocator is configured to, in the event of failure of a satellite spot, extend the zone of coverage of the satellite spots adjacent to the failing satellite spot so as to cover the surface that it occupies, and to allocate new spectral resources to the satellite terminals of the failing satellite spot as a function of their position.

Advantageously, the resource allocator is configured to associate orthogonal polarizations with adjacent satellite spots when the network of spots is fully functional.

In detail, the extension of the zone of coverage of the satellite spots adjacent to the failing satellite spot comprises:
a dividing-up of the surface of the failing satellite spot into N sub-parts formed so as to minimize the distance with respect to the adjacent satellite spots, with N the number of satellite spots adjacent to the failing satellite spot,
an extension of the surface of the satellite spots adjacent to the failing satellite spot, so as to cover the closest sub-part.

According to an embodiment of a multibeam satellite radiocommunications system according to the invention, the satellite comprises an antenna system configured to ensure a function of transmission to the satellite terminal or terminals, an antenna system configured to ensure a function of reception from the satellite terminal or terminals, an antenna system configured to ensure a function of transmission/reception with the satellite terminal or terminals, or a first antenna system configured to ensure a function of transmission to the satellite terminal or terminals and a second antenna system configured to ensure a function of reception from the satellite terminal or terminals.

Advantageously, at least one of the antennas of the satellite system is a multibeam antenna in which each beam is formed by a plurality of radiating elements, called MFB antenna.

In detail, the radiating elements of the MFB antenna or antennas are configured to allow the simultaneous transmission of signals polarized in two orthogonal polarizations, linked by groups to radiofrequency feeds such that each group of radiating elements forms a satellite beam.

Advantageously, when the antenna is an MFB antenna, groups of radiating elements forming beams of adjacent satellite spots in crossed polarization mode or beams of remote satellite spots associated with a same frequency band and same polarization are linked by passive distribution circuits.

According to an embodiment of a multibeam satellite radiocommunications system according to the invention, at least one of the satellite systems comprises a plurality of antennas.

According to an embodiment of a multibeam satellite radiocommunications system according to the invention, when it comprises at least two satellites each having at least one passive multibeam antenna system, the geographic zone is covered by a first antenna system embedded in a first satellite out of the at least two satellites, and by a second antenna system embedded in a second satellite out of the at least two satellites.

Advantageously, the mesh of the network of satellite spots is of square, rectangular or rhomboid form.

In detail, the at least one multibeam antenna system of the satellite comprises an antenna whose feeds are linked to radiating elements through distribution circuits without the implementation of redundancy circuits.

The invention describes also a method for allocating satellite resources, by a resource allocator in a satellite radiocommunications network comprising at least one satellite terminal and at least one satellite, said satellite having at least one passive multibeam antenna system configured to cover a given geographic zone.

The method described comprises:
an initial step of formation of a network of satellite spots arranged according to a regular mesh in quadrilateral form, of association of spectral resources with said satellite spots such that, for each satellite spot, the spectral resources which are assigned to it differ from those assigned to the adjacent satellite spots, and of allocation of spectral resources to said at least one satellite terminal as a function of its position in the satellite spot network,
a step, performed when a satellite spot is failing, of extension of the zone of coverage of the satellite spots adjacent to the failing satellite spot so as to cover the surface that it occupies, and
a step of allocation of new spectral resources to the satellite terminals of the failing satellite spot as a function of their position.

Finally, the invention describes a resource allocator in a satellite radiocommunications network comprising at least one satellite terminal and at least one satellite, said satellite having at least one passive multibeam antenna system configured to cover a given geographic zone, characterized in that it is configured to implement a method for allocating satellite resources as described previously.

### BRIEF DESCRIPTION OF THE DRAWINGS

The invention will be better understood and other features, details and advantages will become more apparent on reading the following description, given as a nonlimiting example, and from the attached figures, given by way of example.

FIG. 1 schematically represents the different elements of a solution according to the HTS or V-HTS payload state of the art using passive antennas.

FIG. 2 schematically represents a satellite radiocommunications system according to the state of the art, in which the invention can be implemented.

FIG. 3 schematically represents the principle of operation of the passive antennas with multiple feeds per beam, or MFB, antennas.

FIG. 4 gives an example of network of satellite spots defined according to a square mesh, that can be used in a multibeam satellite radiocommunications system according to the invention.

FIG. 5 gives an example of network of satellite spots defined according to a rectangular mesh, that can be used in a multibeam satellite radiocommunications system according to the invention.

FIG. 6a describes the configuration that makes it possible to obtain a network of satellite spots according to a mesh in rhomboid form.

FIG. 6b gives an example of network of satellite spots defined according to a rhomboid mesh, that can be used in a multibeam satellite radiocommunications system according to the invention.

FIG. 7 illustrates the manner in which the invention makes it possible to address the problems of beam failures, on a network of square meshes limited to five meshes.

FIG. 8 illustrates the manner in which the invention makes it possible to address the problems of beam failures, on a network of rhomboid meshes limited to five meshes.

FIG. 9a represents iso-level curves of the beams forming the satellite spots in a network organized according to a square mesh.

FIG. 9b represents an example of power level associated with a satellite beam.

FIG. 10a illustrates a concrete application of the implementation of a satellite system according to the invention, in nominal operation.

FIG. 10b illustrates a concrete application of the implementation of a satellite system according to the invention, in degraded operation where half of the beams are failing.

FIG. 11 is a diagram representing the different steps of a method for allocating spectral resources in a multibeam satellite system according to the invention.

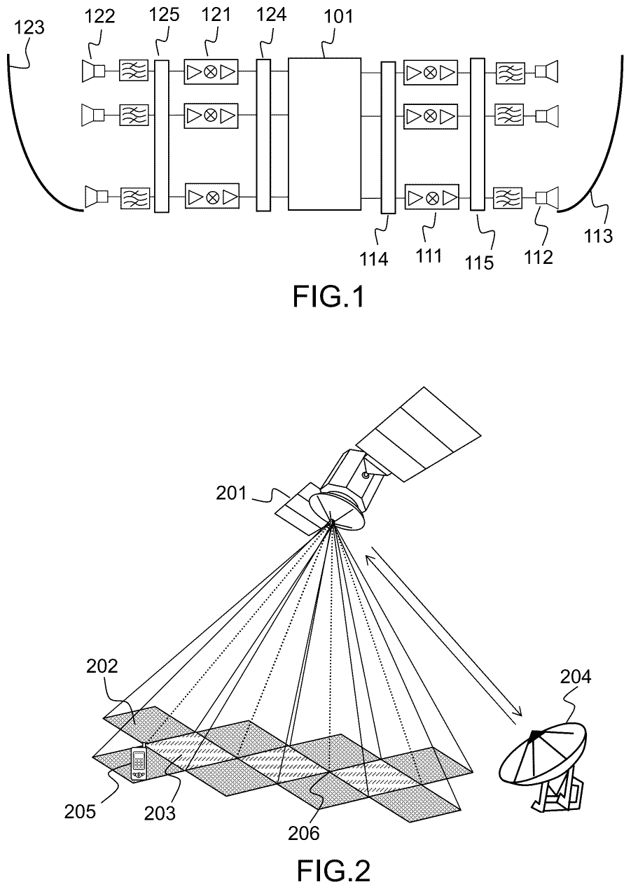

Identical references may be used in different figures when they designate identical or comparable elements.

### DETAILED DESCRIPTION

FIG. 2 schematically represents a satellite radiocommunications system in which the invention can be implemented. It comprises a satellite 201 with one or more antenna systems making it possible to cover a geographic zone of given service by generating a large number of beams in order to form satellite spots such as the spots 202 and 203. According to the embodiment, the antenna system can be formed by one or more passive antennas. In the example of FIG. 2, and as illustration only, the geographic zone of service considered is covered by eleven satellite spots arranged according to a mesh of square form. The notion of satellite spots is a functional representation corresponding to a distribution of the spectral resources on the ground. The square meshes comprise quadrilateral points such as the point 206, at the intersection of iso-roll-off contours of four adjacent satellite spots. The invention applies in the context of satellite spots formed according to a paving in the form of regular meshes having a quadrilateral form, such as, for example, squares, rectangles or rhomboids, provided that, for each satellite spot, distinct spectral resources (frequency channel or polarization) are assigned to this spot and to the satellite spots having an adjacent edge. The scheme used hereinafter in the description is the scheme used in almost all satellite systems, in which a satellite spot is surrounded by spots in counter-polarization mode. However, the invention applies identically in the case where each spot and its four neighbours have the same polarization and distinct frequencies.

The form of the mesh of the network of satellite spots is in the image of the focal array, that is to say that it depends on the form and on the position of the radiating apertures of the satellite antenna and characteristics of the beams formed, in particular the roll-off. A square mesh can be obtained using one or more SFB (acronym for Single Feed per Beam) or MFB (acronym for Multiple Feed per Beam) antennas whose radiating elements are arranged according to a square mesh. A network of satellite spots arranged according to a rectangular or hexagonal mesh can be obtained using one or more MFB antennas whose radiating apertures are arranged according to a hexagonal mesh.

A resource allocator 204, linked to the satellite by a remote control/telemetry link, positioned inside or outside of the geographic zone covered, is configured to:
divide up the geographic service zone into a network of satellite spots forming a regular mesh, as a function of the configuration of the antenna system,
assign each satellite spot specific spectral resources (frequency band and polarization state) by optimizing the allocation of the spectral resource, and
assign spectral resources to the satellite terminals 205 as a function of their position in the network of satellite spots.

The optimization of the assignment of the spectral resources consists in maximizing the distance between the satellite spots associated with the same spectral resources, so as to avoid interferences. As an illustration, in the example of FIG. 2, the dark satellite spots, such as the satellite spot 202, are associated with a first polarization state, while the light satellite spots, such as the satellite spot 203, are associated with a second polarization state orthogonal to the first. These polarizations are generally rectangular or circular polarizations. The beams using the same polarization share the available frequency band by dividing it up into sub-bands, and by maximizing the distance between two satellite spots using the same frequency sub-band. This operation is well known to the person skilled in the art, and forms the subject of numerous satellite communication standards.

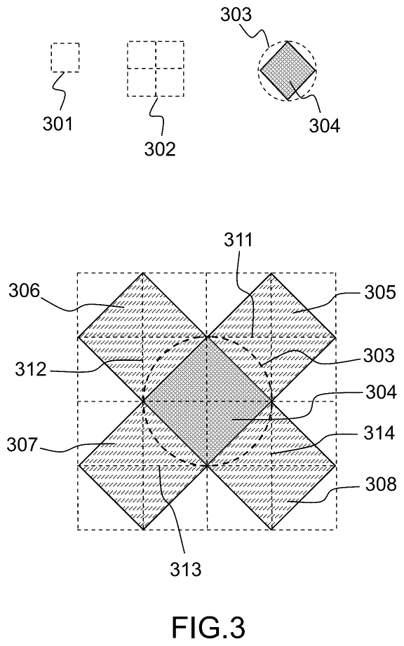

The passive multibeam antenna structures MFB are described for example in the patents EP 2.669.138 B1 and EP 3.082.275 B1. The principle consists here in forming beams from four radiating elements linked to a same amplification chain, by using polarization horns. The term MFB antenna then applies, by contrast to the SFB antennas in which one feed is associated with a radiating element. Other configurations are possible, for example by linking two radiating elements per feed, three radiating elements per feed, 16 radiating elements per feed, etc. Hereinbelow, groupings of radiating elements in bundles of four will be taken as the example, by way of illustration only, the invention applying independently of the size of the groupings. The advantage of the MFB antennas over the SFB antennas is that they exhibit very high properties of directivity and therefore of capacity to reuse spectral resources, which makes it possible to increase the density of the network. The principle of operation of the MFB passive multibeam antennas and an example of form of the corresponding satellite spots are described in FIG. 3, in the context of an antenna for which the radiating elements are horns of square aperture disposed according to a square mesh.

The MFB antennas use bipolarization radiating elements, also called horns or polarization duplexers (or OrthoMode Transducer, OMT), associated by groups of adjacent radiating elements, four in the example, linked to a same transmission or reception RF chain, such that they form together a beam covering a satellite spot. The reference 301 designates the projection onto the coverage on the ground of the beam formed by a square radiating element, the reference 302 represents the projection onto the coverage on the ground of a group of adjacent radiating elements. In the example of FIG. 3, the horn is square, which is the optimal arrangement for a network of satellite spots arranged according to a square mesh, but other forms are possible. The adjacent radiating elements of an MFB antenna form a beam 303 covering a satellite spot 304 whose form is chosen as a function of the configuration of the antenna. The reference 303 represents an iso-contour of the beam. Each radiating element contributes to the formation of two adjacent beams in different polarizations. The squares 311, 312, 313 and 314 represent the projection of four radiating elements of the MFB antenna onto the coverage on the ground. The beam 303 results from the contribution of these four radiating elements in the polarization P1. These radiating elements also each contribute to the formation of a second spot in the orthogonal polarization P2. For example, the radiating element 311 contributes to the formation of the spot 305. The radiating element 312 contributes to the formation of the spot 306, etc. The satellite spots that have a common edge are therefore necessarily associated with orthogonal polarizations. The vertices of the satellite spots, or quadruple points, correspond to the points of intersection of the iso-contours of the adjacent beams. With the exception of the edges of the network, each satellite spot is surrounded by four adjacent satellite spots associated with the orthogonal polarization. It should be noted that the invention applies also in the case of an SFB antenna in which all the satellite spots use the same polarization, provided that each satellite spot and its four neighbouring spots employ different frequency bands.

In FIG. 3, a single MFB antenna ensures the coverage of all of the zone so as to best show the definition of square satellite spots, in transmission, in reception or in transmission/reception mode. Other implementations are possible to obtain a network of satellite spots whose mesh has a quadrilateral form, and in which the satellite spots with an adjacent edge are in orthogonal polarizations. For example, a network of satellite spots defined according to a square mesh can be obtained using a satellite system composed of two SFB antennas each associated with a polarization state in order to ensure all of a complete coverage of the geographic zone, or by complementing antenna systems embedded on two different satellites.

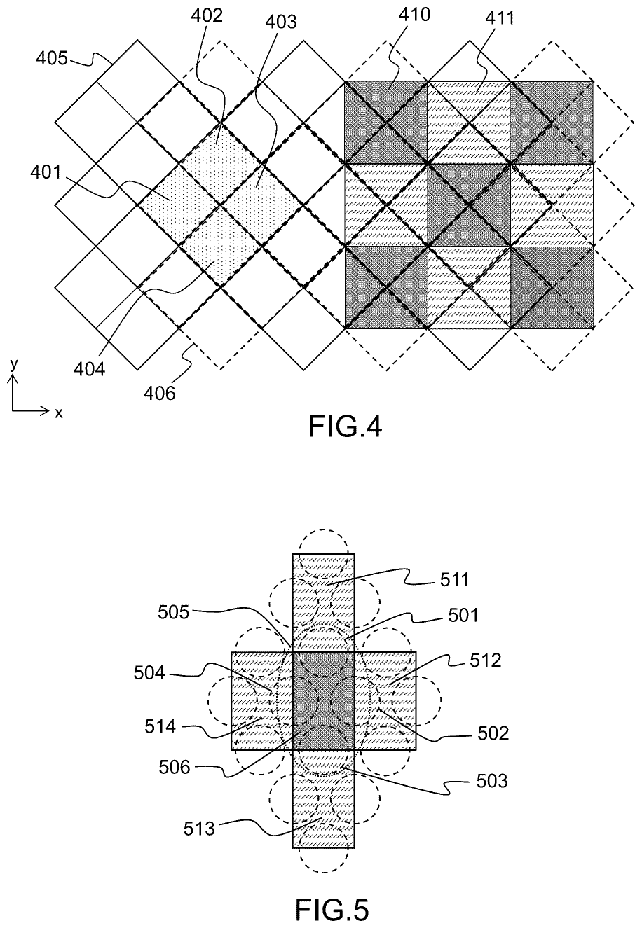

FIG. 4 represents an example of network of satellite spots defined according to a square mesh by a resource allocator, suitable for implementing a satellite radiocommunications system according to the invention. The network of satellite spots is formed from an antenna system composed of two MFB antennas. The two antennas have bipolarization radiating elements in the form of square horns. The radiating elements are, in this example, linked by groups of four to form the beams of the antenna, but other configurations are possible. In FIG. 4, the zones 401, 402, 403 and 404 correspond to the projection on the ground of the iso-contours of four radiating elements linked to the same RF feed of a satellite antenna. The squares in solid lines, like the square 405, represent the projections of groups of radiating elements of the first antenna, and those in dotted lines, like the square 406, represent the projections of groups of radiating elements of the second antenna. Each antenna is configured so as to form adjacent beams in a single direction, the direction y in the example. Thus, the radiating elements corresponding to the iso-contours 402 and 406 each contribute to the formation of beams in crossed polarizations for two adjacent spots. In the direction X, the adjacent spots are formed by beams originating from each antenna alternately, such that the radiating elements 401 and 403 each contribute only to the formation of the beam of a single satellite spot. The satellite spots resulting from this antenna system configuration are represented for example as 410 for the first polarization and 411 for the second polarization. With the exception of the edges of the network, each satellite spot is surrounded by four adjacent satellite spots associated with the orthogonal polarization.

FIGS. 3 and 4 represent two different embodiments making it possible to obtain a geographic zone coverage according to a square mesh, with adjacent spots associated with adjacent polarizations, from one or two MFB antennas.

The use of a plurality of antennas, SFB or MFB, to form the coverage of the geographic zone makes it possible to better control the roll-off (that is to say the variation of the gain between the centre of the spot and the edge of the spot) at quadruple points, and therefore increase the density of the network of satellite spots.

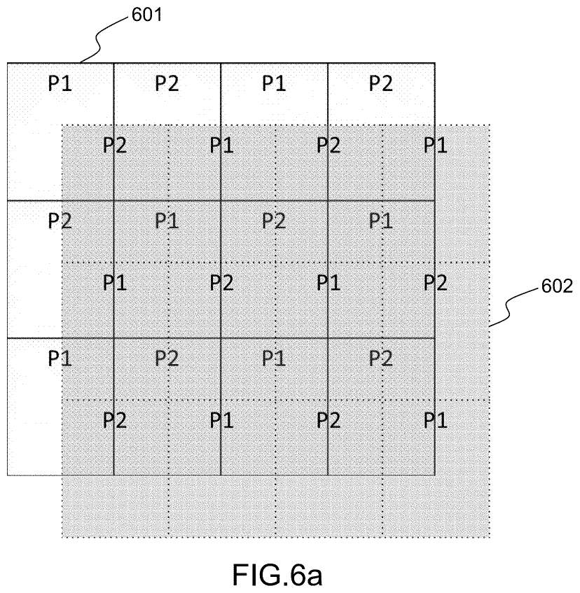

FIG. 5 represents an example of implementation of an MFB antenna making it possible to cover all of a geographic zone of interest with a mesh of rectangular form and adjacent spots in crossed polarization mode. One such antenna is adapted to implement a satellite radiocommunications system according to the invention. The dotted-line circles, like the circles 501 to 504, represent the iso-contours of the beams formed by the radiating elements of the antenna. These radiating elements are, here, horns of circular or hexagonal aperture, disposed according to a hexagonal arrangement. In the example, each radiating element is configured to allow the simultaneous transmission of two signals in crossed polarizations. They are linked by groups to the same transmission or reception radio chains, such that four adjacent radiating elements contribute together to the formation of a same beam. For example, the radiating elements forming the beams of the iso-contours 501 to 504 together contribute to the formation of the beam 505. The optimal paving for this disposition is a paving of rectangle form, like the satellite spot 506 in a first polarization and the adjacent satellite spots 511 to 514 in the orthogonal polarization. Each radiating element further contributes to the formation of a spot adjacent to the spot 506 in the orthogonal polarization: for example, the radiating element forming the beam corresponding to the iso-contour 501 contributes also to the formation of the spot 511 in the crossed polarization. The same applies for the radiating element originating from the beam 502 with the spot 512, etc. The vertices of the satellite spots, or quadruple points, correspond to the points of intersection of the iso-contours of the adjacent beams. With the exception of the edges of the network, each satellite spot is surrounded by four adjacent satellite spots associated with the orthogonal polarization.

In FIG. 5, a single MFB antenna (in transmission, in reception or in transmission/reception mode) ensures the coverage of all of the zone so as to best show the definition of rectangular satellite spots. However, other implementations are possible, for example by using a satellite system comprising two MFB antennas configured to each produce the coverage of half of the geographic zone, in a way comparable to what is illustrated in FIG. 4 for a paving of square form.

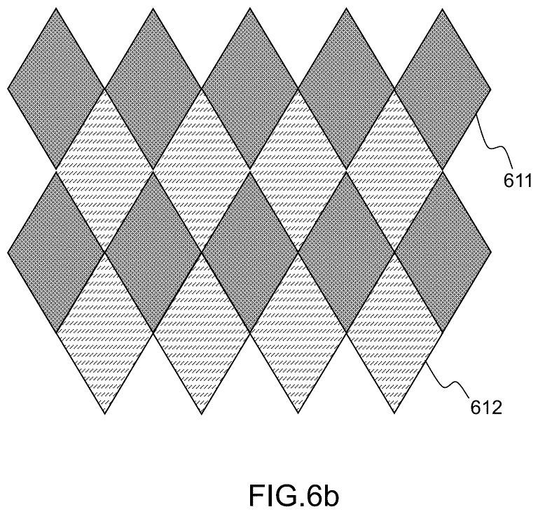

It is also possible to overlay two rectangular pavings on the signals transmitted by two distinct antennas, embedded or not on the same satellite, to form a paving of spots in the form of rhomboids, as represented in FIGS. 6a and 6b.

In FIG. 6a, the reference 601 designates a rectangular mesh of satellite spots covering a given geographic zone, as described and represented in FIG. 5. Such a paving can be obtained by using one or more MFB antennas. The reference 602 designates a second rectangular mesh of satellite spots. The spots of two meshes 601 and 602 are of identical sizes. The polarizations of the satellite spots are designated P1 (polarization 1) and P2 (polarization 2), P1 and P2 being orthogonal polarizations.

The two satellite systems making it possible to implement the two pavings 601 and 602 are configured such that the meshes have an offset of a half-mesh. The resulting optimal paving is given in FIG. 6b. This is a paving according to a mesh in the form of rhomboids, in which each satellite spot has, for its adjacent spot, a spot associated with the crossed polarization. The satellite spots in dark grey, such as the satellite spots 611, use the polarization P1, while the satellite spots with the scored background, such as the satellite spot 612, use the crossed polarization P2. With the exception of the edges of the network, each satellite spot is surrounded by four adjacent satellite spots associated with the orthogonal polarization. Such a mesh is suitable for the implementation of a method for allocating satellite resources according to an embodiment of the invention.

The overlaying of two rectangular or square meshes therefore makes it possible to produce a mesh in the form of rhomboids, with double the number of satellite spots and optimal management of the performance levels, in particular at the points corresponding to the quadruple points of the rectangular/square meshes. The two meshes can be implemented by a satellite system comprising two MFB antennas, or by two satellite systems embedded on two distinct satellites each having one MFB antenna. Thus, a first satellite can be launched so as to cover the geographic zone by a mesh of rectangular satellite spots, then a second satellite can be launched later to add the additional antenna system making it possible to cover the geographic zone by a mesh of satellite spots in the form of rhomboids, in order to increase the density of the network.

The invention relates to a radiocommunications system implementing a passive multibeam antenna system, that is to say a multibeam antenna system in which the amplification chains are directly linked to the radiating elements, without redundancy circuits. The antenna system therefore has optimal performance levels, as well as good availability and a small payload compared to the active multibeam antenna systems. In the radiocommunications system according to the invention, the failure of a beam gives rise to a rearrangement of the structure of the network, linked with the configuration of the antenna system.

The method according to the invention is implemented in a multibeam satellite radiocommunications system such as that described in FIG. 2, which comprises one or more satellites (201), each satellite being able to have a transmission antenna system and/or a reception antenna system, or a transmission/reception antenna system. The distinction between transmission satellite system and reception satellite system is advantageous because it makes it possible to better control the power of the beams, in particular the quadruple points, since the uplink and downlink satellite communications use distinct frequency bands.

The satellite radiocommunications system also comprises one or more satellite terminals 205 and a resource allocator 204.

In the satellite radiocommunications system according to the invention, at least one of the antenna systems and the resource allocator are configured to form a regular network of satellite spots over a given geographic zone, according to a regular mesh in quadrilateral form (square, rectangle or rhomboid), as described in FIGS. 3 to 6b. The resource allocator is configured to associate spectral resources with the satellite spots, such that adjacent satellite spots, that is to say satellite spots having common edges, are associated with orthogonal polarizations, as described in FIGS. 3 to 6b, or that, for each spot, distinct frequency bands are assigned to the spot and to its four neighbours. Frequency bands are also associated with the satellite spots, being careful as far as possible to maximize the distance between satellite spots associated with the same frequency bands. The resource allocator is also configured to allocate to the satellite terminals spectral resources (frequency band and polarization) as a function of their positions in the network of satellite spots.

The satellite radiocommunications system according to the invention has the particular feature that the resource allocator is configured to modify the mesh of the network of satellite spots each time a satellite spot fails. In the event of failure of a satellite spot, it extends the zone of coverage of the satellite spots adjacent to the failing satellite spot, so as to cover the surface that it previously occupied, and allocates new spectral resources to the satellite terminals of the failing satellite spot. Failure of a satellite spot is understood for example to mean a failure on the RF amplification chain associated with the beam covering the spot. Since the antenna system is a passive system, in a non-redundant satellite radiocommunications system according to the state of the art, such a failure necessarily leads to a hole in the covering of the satellite.

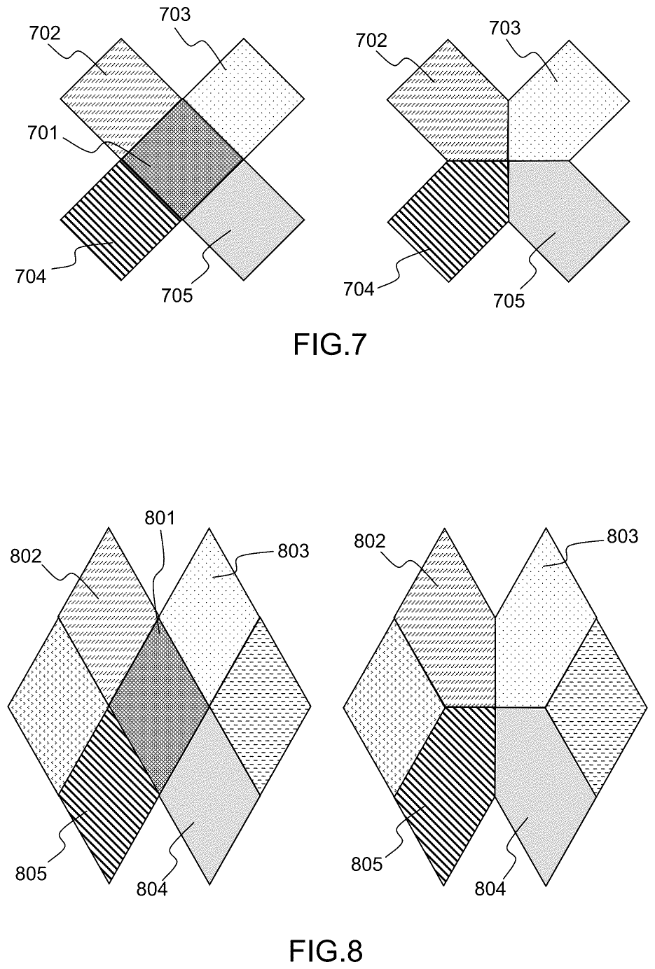

FIG. 7 illustrates the manner in which the network of satellite spots is modified by the resource allocator according to the invention in the case where a satellite spot is failing. The example is given in a network of satellite spots having a square mesh, limited in this example to five spots.

The left of FIG. 7 represents a smaller network of satellite spots in nominal operation. It here comprises five satellite spots 701 to 705, associated with spectral resources by the resource allocator such that adjacent satellite spots use orthogonal polarizations. By designating P₁ and P₂ orthogonal polarizations, and for a colouring scheme with four frequency bands F₁ to F₄, i.e. a colouring scheme with N=8 colours, it is for example possible to have the following associations:
satellite spot 701: (F₁, P₁),
satellite spot 702: (F₁, P₂),
satellite spot 703: (F₂, P₂),
satellite spot 704: (F₃, P₂),
satellite spot 705: (F₄, P₂),

These associations are given purely by way of example, the number of frequencies being advantageously able to be increased to increase the distance between satellite spots using the same spectral resources. It is also possible to assign distinct frequencies F1 to F5 to each of the spots, in the same polarization.

The right of FIG. 7 represents the embodiment of the invention in the case of failure of the satellite spot 701. In this case, the resource allocator is configured to extend the surface covered by the satellite spots 702 to 705 having edges in common with the spot 701, such that they together cover all of the surface of the failing satellite spot 701.

This extension of surface of the spots is done in two steps:
the surface associated with the satellite spot 701 is divided up into N sub-parts formed so as to minimize their distance with respect to the adjacent satellite spots, with N the number of adjacent satellite spots. In most cases, and in the example of FIG. 7, N is equal to 4, but the number of sub-parts can be less on the edges of the network,
the surface of the satellite spots adjacent to the failing satellite spot is extended so as to cover the closest sub-part or sub-parts.

Thus, in the event of failure of the amplification chain associated with a satellite spot, the resource allocator performs an angular extension of the coverage of the adjacent satellite spots by reallocating to them the geographic zone initially covered by the failing satellite spot. These spots then compensate for the link to the satellite terminals of the failing spot. New spectral resources are therefore then allocated to them by the resource allocator as a function of their positions. This principle guarantees the continuity of coverage of the satellite without it being necessary to implement redundancy circuits in the antenna system.

The use of a scheme of re-use of the spectral resources with 8 colours or more makes it possible to guarantee the absence of interferences between distinct satellite spot links, in particular at the quadruple point (centre of the spot) of the zone initially covered by the satellite spot 701. The invention does however also apply for a scheme of re-use of the spectral resources with 4 colours, provided that distinct frequency sub-bands are allocated to the zones overlapping the surface of the satellite spot 701 in case of failure, in order to avoid the interferences.

It is possible to manage the interferences by using a scheme of re-use of the spectral resources with 2 colours only, i.e. one frequency band and two orthogonal polarization states. This mode of operation is described in the patent EP 3.082.275 B1, and can be adapted to a satellite radiocommunications network according to the invention. In this case, a spectral reserve of approximately 20% of the total band is allocated to the users in order to manage the interferences at the quadruple points of the satellite spots.

The same principle applies in an equivalent manner in the case of a network of satellite spots in the form of rectangles, as illustrated in FIG. 5, or of rhomboids, as illustrated in FIG. 6b. For the rhomboids, the implementation of the invention is comparable to that of FIG. 7. It is illustrated in FIG. 8, where the left of the figure represents the nominal case in which all of the satellite spots are functional, and the right of the figure represents the case in which the spot 801 is failing. In this case, the adjacent satellite spots 802 to 805 are extended so as to cover the surface that the spot 801 occupies. New spectral resources are then allocated to the user terminals of the spot 801 as a function of their position.

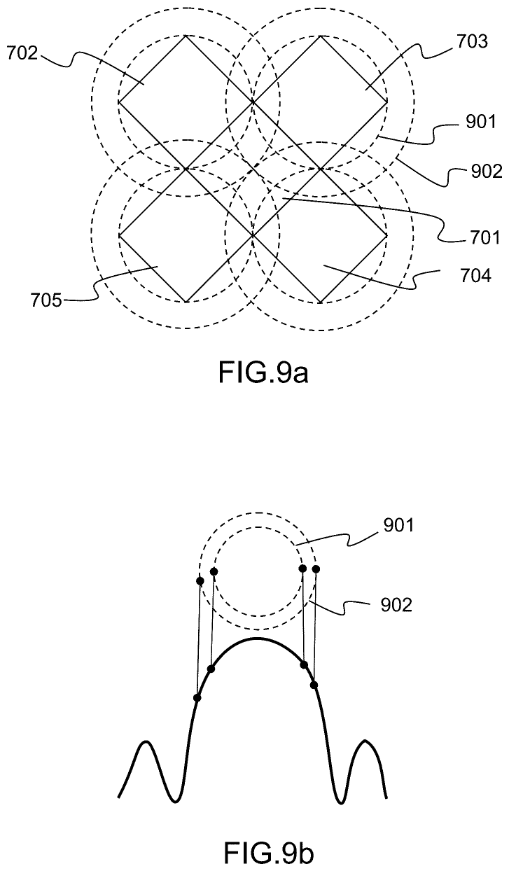

The invention exploits the fact that the power flux radiated by the beams illuminating the satellite spots does not stop at the boundary of the spots, in particular when the satellite spots have quadrilateral forms. The power flux emitted in the adjacent spots can be sufficient to maintain a communication in case of hardware failure of the amplification chains of the central spot. FIGS. 9a and 9b illustrate this principle on the basis of a network of satellite spots organized according to a square mesh, as in FIG. 7. The curve 901 represents the iso-power level of the beam illuminating the satellite spot 703 at the quadruple point. The curve 902 represents the iso-power level of the beam illuminating the satellite spot 703 at the centre of the spot 701. FIG. 9b gives an example of power level emitted by a satellite beam. It can be seen therein that the power level on the iso-level 902 can be close to the power level on the iso-level 901.

The invention applies therefore in particular to the networks of satellite spots for which the power flux emitted in the adjacent spots is sufficient to be able to extend the satellite spots over a part of these spots. Such is the case for example when the network of satellite spots has a square mesh with an alternation of spots in crossed polarizations obtained from an antenna system comprising two SFB antennas or SFB antenna systems in a double square mesh grid. This solution is more difficult to envisage for the antenna systems with one SFB antenna in a square mesh, because it creates a constraint on the dimensions of the horns which must be smaller, which leads to overflow losses through a lack of directivity. The use of one or more MFB antennas is particularly suited to this implementation, in particular for a network of satellite spots and a coverage by a mesh in quadrilateral form, since these antennas make it possible to form beams with significant power levels on the edges and at the quadruple points of the quadrilaterals. This solution further makes it possible to increase the density of the coverage through the step-by-step re-use of the radiating elements.

The satellite radiocommunications network according to the invention therefore makes it possible to address the problem of unavailability of the beams, linked for example to the failures of the amplification RF chains of the signals transmitted/received at the feeds of the antenna, while having an optimal management of the power consumed by the satellite and a dense network of satellite spots.

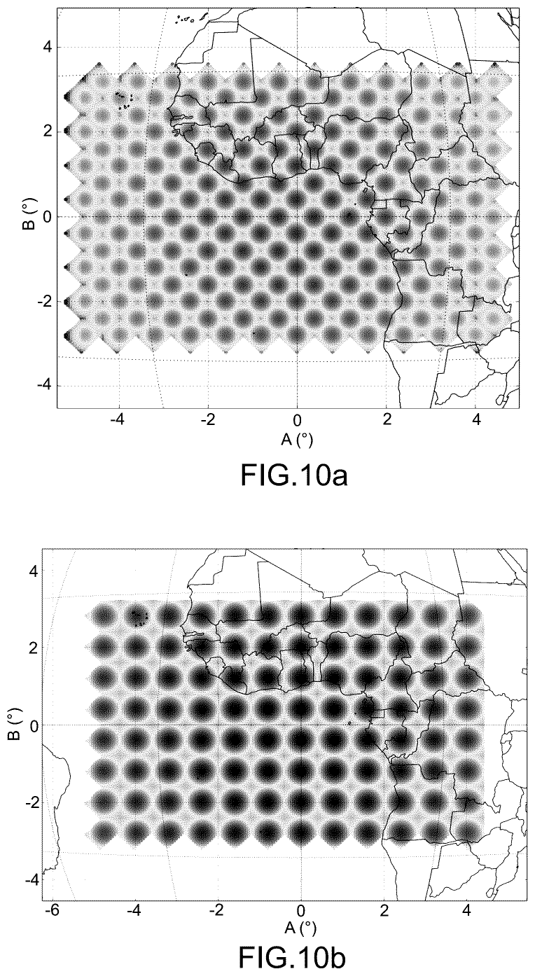

FIGS. 10a and 10b illustrate a concrete application of the coverage of a geographic zone in a satellite radiocommunications network according to the invention, for a satellite having an MFB multibeam passive transmission/reception antenna with 192 points (that is to say 192 RF chains). Each amplification chain of the antenna is linked to a quadruplet of bipolarization radiating elements arranged according to a square mesh, making it possible to form a network of satellite spots according to a square mesh with an alternation of satellite spots associated with crossed polarizations. In the example, the antenna forms a beam aperture of 0.7°, with a scheme of re-use of the frequencies with 8 colours. FIG. 10a shows, in grey levels, the powers available in the different meshes in a case of nominal operation, the black corresponding to the maximal power level. The level of directivity in the middle of the meshes is slightly greater than 47.2 dB and the gain variation is of the order of 3 dB. FIG. 10b represents the same geographic zone, in a case of degraded operation in which all of the satellite spots associated with a given polarization are failing. For each failing satellite spot, the resource allocator modifies the form of the adjacent satellite spots associated with the crossed polarization, as described previously, so as to compensate for this spot. It can be seen that the continuity of service of the geographic zone is ensured, even with a 50% failure rate. The square meshes have a size two times greater since each spot mitigates the failure of the four surrounding satellite spots. Inevitably, the power level in the failing satellite spots is slightly reduced given the failure rate.

The satellite radiocommunications system according to the invention therefore makes it possible to offer a complete geographic coverage of a geographic zone, even when 50% of the beams are out of service. It makes it possible to design satellite antennas that have non-redundant Tx and Rx sections, in which the RF circuits are directly linked to the feeds of the antenna through the distribution circuits, which makes it possible to:
eliminate the ohmic losses due to the redundancy circuits,
minimize the cable loom lengths,
minimize the weight of the payload,
reduce the integration and path verification times.

As an illustration, a conventional payload in Ka band generally uses TWTA amplifiers to maximize the amplification efficiencies (typical efficiency of 48% in multicarrier mode). However, the ohmic losses linked to a redundant architecture after the power amplifier are typically of the order of 2.5 dB. The output section thus constituted exhibits an efficiency of 27% at the feed port.

The proposed solution makes it possible to eliminate the redundancy circuits, and therefore to use SSPA amplifiers that are smaller, less heavy, less expensive, with reduced efficiencies (typical efficiency of 33% in the state of the art) positioned sufficiently close to the radiating apertures to limit the ohmic losses to less than 0.5 dB. The output section thus constituted then exhibits an efficiency of 29% at the feed port. This solution is therefore better than the conventional solution for much lesser complexity and weight. The proposed solution can also be associated with TWTA amplifiers to offer in this case efficiency of 43% at the feed port.

The satellite radiocommunications system according to the invention uses known technologies onboard the satellite. The antenna systems can comprise one or more multibeam passive antennas, jointly or separately handling the transmission and reception functions. In Ka band, the frequency band authorized for transmissions (downlink) is the [27.5 GHz-31 GHz] band whereas the frequency band authorized for receptions (uplink) is the [17.3 GHz-21.2 GHz] band. The roll-off factor of the beams formed (that is to say the variation of gain in the satellite spot, which is a function of the reflector diameter) is a function of the wavelength. For example, the angle θ3 dB corresponding to 3 dB of roll-off is equal to 70 λ/D, with λ the average wavelength of the frequency band envisaged and D the diameter of the reflector. Thus, the feeds and reflectors of the satellite antennas simultaneously handling transmission and reception are generally dimensioned with respect to the constraints of the downlink, that is to say the lowest wavelength. Because of this, the roll-off of the beams used for the uplink is therefore generally too strong. Differentiating the transmission and reception antenna systems makes it possible to control the roll-off for each of the up and down links, and therefore the transmitted power levels, so as to limit the interferences that can occur at the centre of the failing satellite spots when the scheme of re-use of the frequencies uses a small number of frequency sub-bands.

According to the applications targeted, the satellite radiocommunications system according to the invention can apply only to a single direction of the communication, the uplink communications or the downlink communications, or to both communication directions. It is also possible to have a dissymmetrical system, such as for example by using in transmission an antenna system comprising two antennas according to a configuration making it possible to produce a paving in the form of rhomboids, and in reception an antenna system comprising an antenna according to a configuration making it possible to produce a paving in the form of rectangles, the solid angle of the rectangles being equal to twice the solid angle of the rhomboids. In fact, since implementing redundancy in the amplification chains is simpler in reception than in transmission (because there is no power involved), it is then possible to introduce redundancy chains that are not complex in the payload of the satellite system.

The satellite radiocommunications system according to the invention offers the advantage of being compatible with all the satellite communication standards, and does not entail modifying the user terminals developed to implement these standards.

Finally, the satellite radiocommunications system according to the invention offers the advantage of being compatible with the implementation of other mechanisms, such as, for example, the beam coupling mechanism described within the patent application EP 3.503.430 A1, which makes it possible to address the issues of compound coverage (Beam Layout) from networks in MFB configuration using regular coverages. The principle consists in coupling beams of the same size via passive distribution circuits, either adjacent beams in counter-polarization mode or remote beams associated with a same frequency sub-band and a same polarization, in order to constitute equivalent beams in which the solid angle is a multiple of the solid angle of the elementary beams.

For a given number of repeater ports, the beam coupling allows for a simple and efficient optimization of the distribution of the capacity on a non-uniform coverage from a network providing a regular coverage. It also makes it possible to improve the performance levels of the satellite radiocommunications systems in terms of directivity and in terms of C/I (acronym for Carrier to Interference, or signal to interference ratio) with respect to the conventional systems.

The invention relates to a complete satellite radiocommunications system, comprising satellite, satellite antenna, resource allocator and satellite terminal, but also to the allocator itself in such a system, configured to mitigate the possible extinguishing of satellite beams by extending the coverage of the adjacent meshes in counter polarization mode. Finally, it relates to a method for allocating spectral resources (frequency band and polarization) in a multibeam satellite system as described previously.

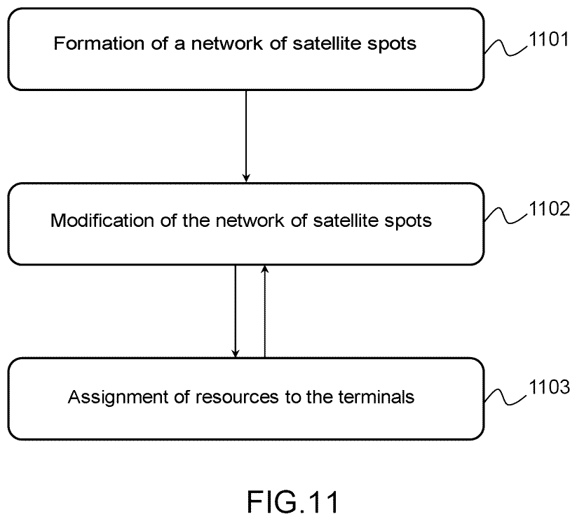

The method for allocating resources in a satellite network according to an embodiment of the invention, the steps of which are represented in FIG. 11, comprises three steps:
an initial step 1101, performed by the resource allocator 204, of formation of a network of satellite spots arranged according to a regular mesh in quadrilateral form, for example square, rectangular or rhomboid, then of association of spectral resources to the satellite spots. The associations of spectral resources (frequency bands/polarization pairing) are made such that orthogonal polarizations are assigned to adjacent satellite spots, or failing that only for each spot, distinct frequency resources are assigned to the spot concerned and to its four neighbours. The resource allocator then allocates spectral resources to each satellite terminal of the network, as a function of its position in the network of satellite spots. This allocation of spectral resources is also performed each time a satellite terminal enters into the network. This step can be performed just once when the satellite is started up, or regularly/on demand in order to adapt the frequency resource allocations to the payload and to any movements of the terminals,
a step 1102, performed by the resource allocator each time a satellite spot (such as the spot 701) is failing, of extension of the coverage zone of the adjacent satellite spots (702, 703, 704 and 705) so as to cover the surface that it occupies. This step makes it possible to ensure the continuity of the coverage of the service zone in the event of failure of the beam covering a satellite spot, while dispensing with redundancy circuits;
a step 1103, performed immediately following the step 1102, of allocation of spectral resources to the satellite terminals of the failing satellite spot, as a function of their position and of the new configuration of the network of meshes.

1. A multibeam satellite radiocommunications system comprising:
at least one satellite having at least one passive multibeam antenna system,
at least one satellite terminal,
a resource allocator configured to form a regular network of satellite spots over a given geographic zone, said satellite spot network being arranged according to a regular mesh in the form of quadrilaterals, and to associate spectral resources to the satellite spots such that, for each satellite spot, the spectral resources which are assigned to it differ from those assigned to the adjacent satellite spots, then to allocate spectral resources to said at least one satellite terminal as a function of its position in said satellite spot network,
the satellite radiocommunications system comprising the resource allocator is configured to, in the event of failure of a satellite spot, extend the zone of coverage of the satellite spots adjacent to the failing satellite spot so as to cover the surface that it occupies, and allocate new spectral resources to the satellite terminals of the failing satellite spot as a function of their position.

2. The multibeam satellite radiocommunications system according to claim 1, wherein orthogonal polarizations are associated with adjacent satellite spots.

3. The multibeam satellite radiocommunications system according to claim 1, wherein the extension of the zone of coverage of the satellite spots adjacent to the failing satellite spot comprises:
a dividing-up of the surface of the failing satellite spot into N sub-parts formed so as to minimize the distance with respect to the adjacent satellite spots, with N the number of satellite spots adjacent to the failing satellite spot,
an extension of the surface of the satellite spots adjacent to the failing satellite spot, so as to cover the closest sub-part.

4. The multibeam satellite radiocommunications system according to claim 1, wherein the satellite comprises an antenna system configured to ensure a function of transmission to the satellite terminal or terminals, an antenna system configured to ensure a function of reception from the satellite terminal or terminals, an antenna system configured to ensure a function of transmission/reception with the satellite terminal or terminals, or a first antenna system configured to ensure a function of transmission to the satellite terminal or terminals and a second antenna system configured to ensure a function of reception from the satellite terminal or terminals.

5. The multibeam satellite radiocommunications system according to claim 1, wherein at least one of the antennas of the satellite system is a multibeam antenna wherein each beam is formed by a plurality of radiating elements, called MFB antenna.

6. The multibeam satellite radiocommunications system according to claim 5, wherein the radiating elements of the MFB antenna or antennas are configured to allow the simultaneous transmission of signals polarized in two orthogonal polarizations, linked by groups to radiofrequency feeds such that each group of radiating elements forms a satellite beam.

7. The multibeam satellite radiocommunications system according to claim 5, wherein groups of radiating elements forming beams of adjacent satellite spots in crossed polarization mode or beams of remote satellite spots associated with a same frequency band and the same polarization are linked by passive distribution circuits.

8. The multibeam satellite radiocommunications system according to claim 1, wherein at least one of the satellite systems comprises a plurality of antennas.

9. The multibeam satellite radiocommunications system according to claim 1, and comprising at least two satellites each having at least one passive multibeam antenna system, wherein said geographic zone is covered by a first antenna system embedded in a first satellite out of said at least two satellites, and by a second antenna system embedded in a second satellite out of said at least two satellites.

10. The multibeam satellite radiocommunications system according to claim 1, wherein the mesh of the network of satellite spots is of square, rectangular or rhomboid form.

11. The multibeam satellite radiocommunications system according to claim 1, wherein said at least one multibeam antenna system of the satellite comprises an antenna whose feeds are linked to radiating elements through distribution circuits without the implementation of redundancy circuits.

12. A method for allocating satellite resources, by a resource allocator in a satellite radiocommunications network comprising at least one satellite terminal and at least one satellite, said satellite having at least one passive multibeam antenna system configured to cover a given geographic zone, said method comprising:
an initial step of formation of a network of satellite spots arranged according to a regular mesh in quadrilateral form, of association of spectral resources to said satellite spots such that, for each satellite spot, the spectral resources which are assigned to it differ from those assigned to the adjacent satellite spots, and of allocation of spectral resources to said at least one satellite terminal as a function of its position in the network of satellite spots,
a step, performed when a satellite spot is failing, of extension of the zone of coverage of the satellite spots adjacent to the failing satellite spot so as to cover the surface that it occupies, and
a step of allocation of new spectral resources to the satellite terminals of the failing satellite spot as a function of their position.

13. A resource allocator in a satellite radiocommunications network comprising at least one satellite terminal and at least one satellite, said satellite having at least one passive multibeam antenna system configured to cover a given geographic zone, to implement a method for allocating satellite resources according to claim 12.
